(19) United States
(12) Patent Application Publication
(10) Pub. No.: US 2014/0182973 A1
(43) Pub. Date: Jul. 3, 2014

(54) LIFT FOR ATTIC STAIRCASE

(71) Applicants: John C. Hutchins, Greensburg, PA (US); James J. Hoover, North Huntingdon, PA (US); Christian Chupka, Harrison City, PA (US); John W. Hutchins, Greensburg, PA (US)

(72) Inventors: John C. Hutchins, Greensburg, PA (US); James J. Hoover, North Huntingdon, PA (US); Christian Chupka, Harrison City, PA (US); John W. Hutchins, Greensburg, PA (US)

(21) Appl. No.: 14/139,556

(22) Filed: Dec. 23, 2013

Related U.S. Application Data
(60) Provisional application No. 61/740,486, filed on Dec. 21, 2012.

(51) Int. Cl. B66B 9/08

(52) U.S. Cl. CPC B66B 9/083
USPC 187/245

(57) ABSTRACT

A lift for an attic staircase is provided. The lift includes a base that is attached to a floor near the entrance to the attic. An incline frame may be slidably attached to the base. The incline frame may be oriented at an angle that is substantially the same as the deployed attic staircase. A winch that includes a cable may be used to hoist a cart up the staircase and into the attic.

### CROSS-REFERENCE TO RELATED APPLICATION

This application claims the benefit of priority of U.S. provisional application No. 61/740,486, filed Dec. 21, 2012, the contents of which are herein incorporated by reference.

### BACKGROUND OF THE INVENTION

The present invention relates to a lift and, more particularly, to a lift for a staircase of an attic.

An attic or loft is a space found directly below the pitched roof of a house or other building. Occasionally, the entrance to the attic is through the ceiling of the top floor of the building. In such configurations, a deployable staircase may come down from the ceiling to enter the attic. The deployable staircases tend to be very narrow and transporting items up to the attic may be difficult.

As can be seen, there is a need for a mechanism to easily transport items into the attic.

### SUMMARY OF THE INVENTION

In one aspect of the present invention, a lift for an attic staircase comprises: a base comprising a front end and a rear end, wherein the base is configured to be attached within an attic and wherein the front end is oriented near a plurality of steps leading to the attic; an incline frame attached to the base near the front end of the base, wherein the incline frame is oriented at an angle substantially similar to the angle of the attic staircase; a winch comprising a cable having a first end and a second end, wherein the first end is attached to the winch and the second end comprises an attachment component configured to attach to a cart, wherein the cable runs along at least a portion of the incline frame.

In another aspect of the present invention, a method of transporting items to and from an attic comprises: mounting a base to an attic floor, wherein the base comprises a front end and a rear end, wherein the front end is adjacent to an attic entrance; slidably connecting an incline frame to the base, wherein the incline frame is oriented at a substantially similar angle as a deployable staircase of the attic; providing a winch comprising a cable, wherein the cable runs from the winch and over the incline frame; providing a cart; sliding the incline frame up to the front end of the base; deploying the cable near a bottom of the deployed attic staircase; attaching the cart to the cable; and activating the winch so that the cart is pulled up the deployable staircase and onto the incline frame.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is a perspective view of the base frame and incline frame of FIG. 1;

FIG. 3 is an alternate embodiment of the base frame and incline frame of FIG. 1 with a different orientation of the pulley;

FIG. 4 is a perspective view of the cart of FIG. 1; and

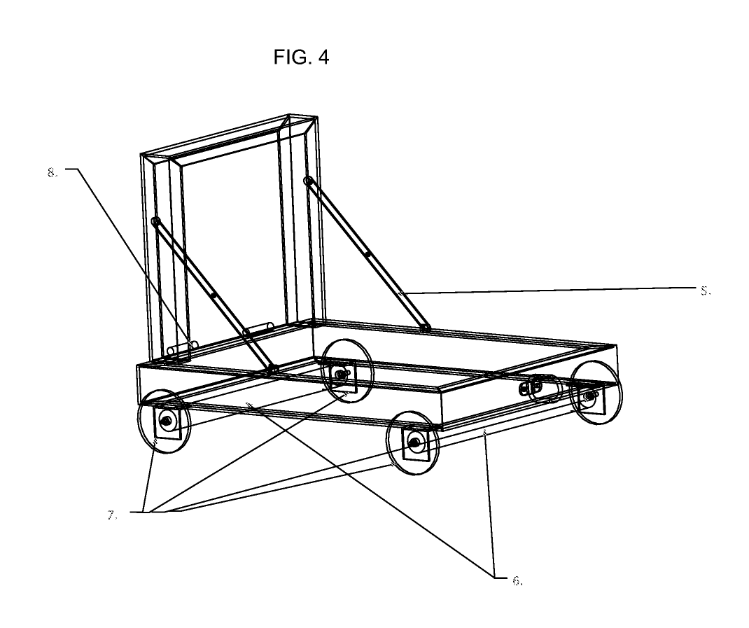

FIG. 5 is a perspective view of an alternate embodiment of the cart of

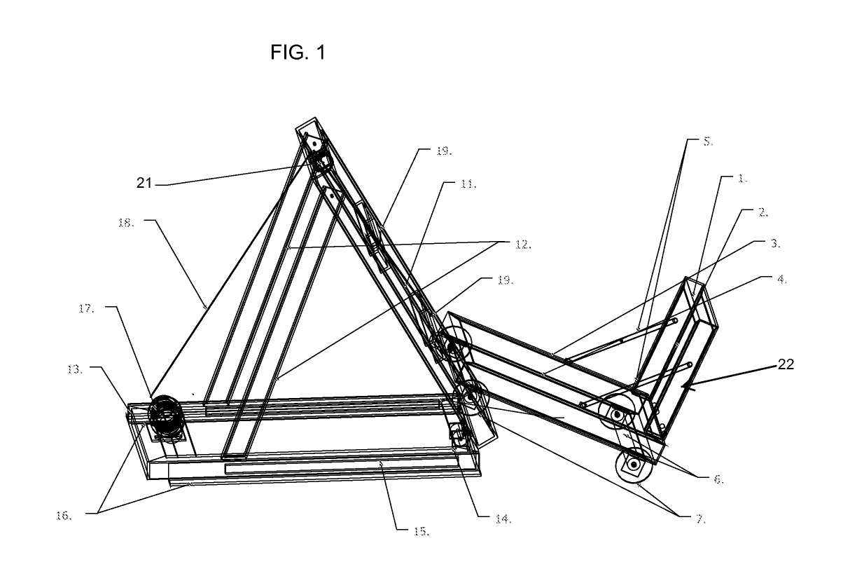

FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a lift for an attic staircase. The lift includes a base that is attached to a floor near the entrance to the attic. An incline frame may be slidably attached to the base. The incline frame may be oriented at an angle that is substantially the same as the deployed attic staircase. A winch that includes a cable may be used to hoist a cart up the staircase and into the attic.

The present invention may include a lift for an attic. The lift may include a base 13, an incline frame 11, and a cart 22. The base 13 may include a front end and a rear end. The base 13 may be attached within an attic so that the front end is oriented near a plurality of steps or the staircase leading to the attic. In certain embodiments, the base 13 may be mounted to the attic floor by a mounting frame 16. The incline frame 11 may be attached to the base 13 near the front end of the base 13. The incline frame 11 is oriented at an angel substantially similar to the angle of the staircase when the staircase is deployed. The present invention may further include a winch 17. The winch 17 may be automated or manually operated. A cable 18 may be connected to the winch 17 at a first end and may have an attachment component at the second end to attach to the cart 22. The cable 18 may run along the incline frame 11.

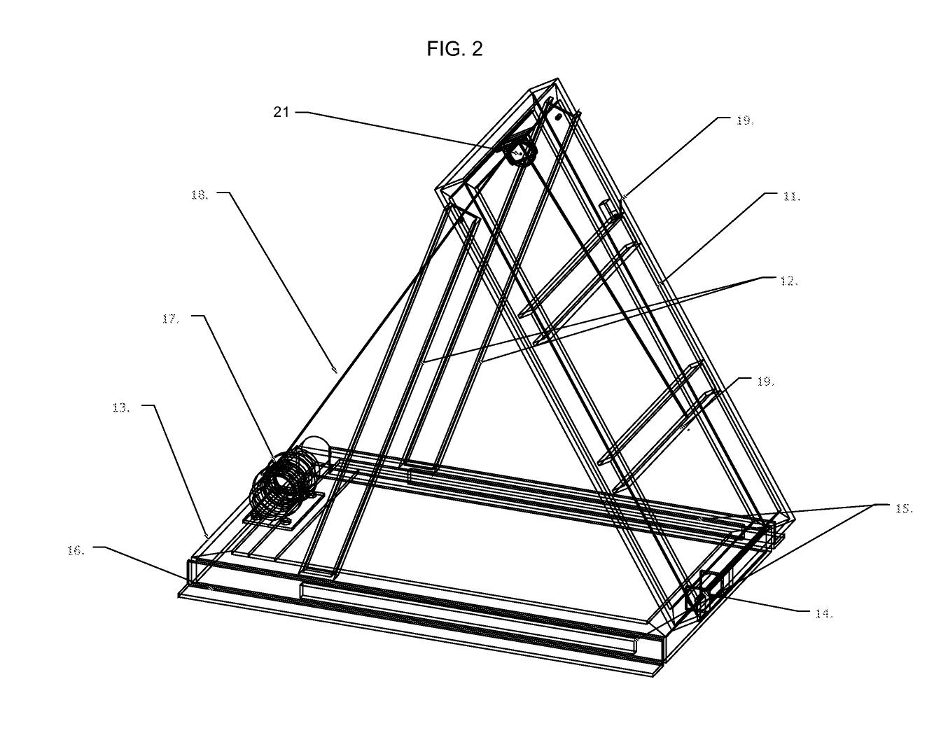

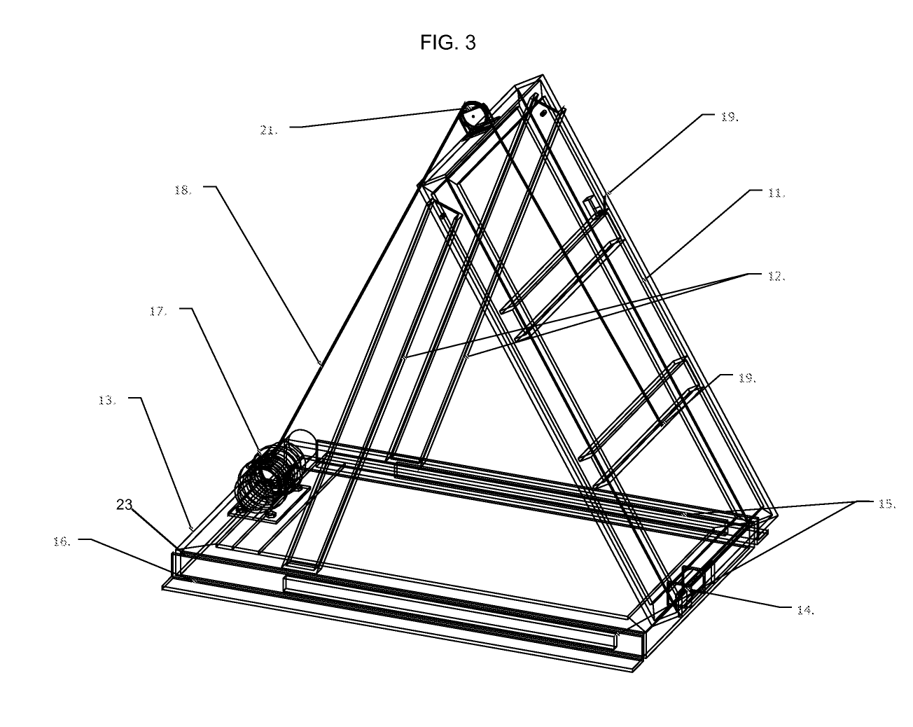

In certain embodiments, the present invention may further include at least one pulley 21. The pulley 21 may be attached near the top end of the incline frame 11. In such embodiments, the winch 17 may be attached to the base 13 near the rear end. The cable 18 may run from the winch 17 and through the pulley 21 and along the incline frame 11. As illustrated in FIG. 2, the pulley 21 may be attached to the bottom side of the top end of the incline frame 11. However, as illustrated in FIG. 3, the pulley 21 may be attached to the top side of the top end of the incline frame 11 as well.

In certain embodiments, the incline frame 11 may be slidably attachable to the base 13. Therefore, the incline frame 11 may be slid from the front end of the base 13 to the rear end of the base 13 and from the rear end of the base 13 to the front end of the base 13. In such embodiments, the base 13 may include channels 23 having at least a first channel 23 and a second channel 23. The incline frame 11 may ridges 15 including at least a first ridge 15 and a second ridge 15 that may fit within the first channel 23 and the second channel 23 respectively. A plurality of rollers 14 may be attached to the incline frame 11 to allow the first ridge 15 and the second ridge 15 to slide along the first channel 23 and the second channel 23.

In certain embodiments, the ridges 15 may include a front end and a rear end. The front end of the ridges 15 may be attached to the bottom end of the incline frame 11 and the rear end of the ridges may be attached to incline supports 12. The incline supports 12 may attach the ridges 15 to the top end of the incline frame 11, thereby adding additional support to the incline frame 11.

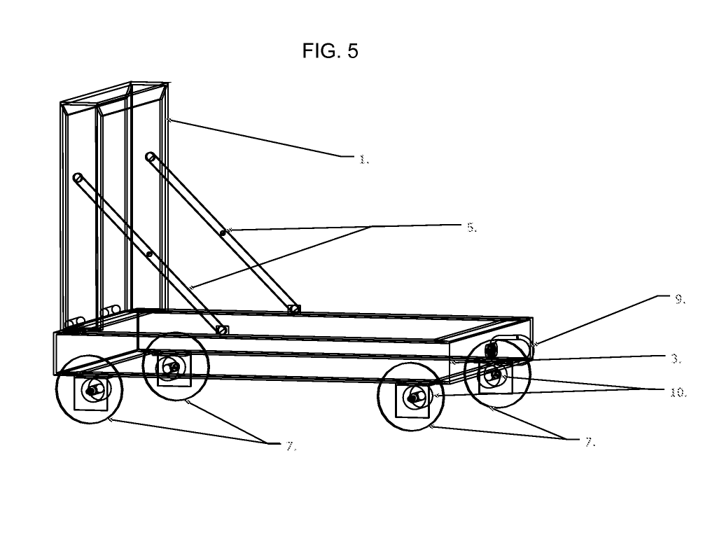

The present invention may further include the cart 22. The cart 22 may include a cart base 3 with a cart bottom 4, where items may rest. The cart 22 may further include a cart back frame 1 comprising a cart back 2. The cart back 2 may protrude from the rear end of the cart base 3 in a substantially perpendicular position relative to the cart base 3. The cart back 2 may prevent items from falling out of the cart when the cart 22 is being transported up the attic staircase. The cart back 2 may be pivotally attached to the cart base 3 by hinge 8 and hinge supports 5. The cart 22 may further include an axle 6 with a plurality of wheels 7 attached to the axle 6. The axle 6 may run completely across the bottom of the cart base 3. However, as illustrated in FIG. 5, the cart may include a split axle 10 configuration.

To use the present invention, the incline frame 11 may be positioned towards the front end of the base 13 to align the incline frame 11 with the attic staircase. The cable 18 may be lowered to the top floor of the building using the winch 17. An attachment component such as a hook on the cable 18 may be attached to a ring 9 attached to the cart 22. Items that need to be stored in the attic may be placed on the cart 22. The cart 22 may be pulled up the staircase by the winch 17. Once the cart 22 has reached the incline frame 11, the incline frame 11 may be pushed towards the rear end of the base 13 so that a user may easily maneuver when in the attic. The items may be removed from the cart 22 or the user may place items within the cart 22 to bring back down to the top floor. The cable 18 may be attached to a cable safety clip 19 when the present invention is not in use.

A method of transporting items to and from an attic may comprise the steps of: mounting a base to an attic floor, wherein the base comprises a front end and a rear end, wherein the front end is adjacent to an attic door; slidably connecting an incline frame to the base, wherein the incline frame is oriented at a substantially similar angle as a deployable staircase of the attic; providing a winch comprising a cable, wherein the cable runs from the winch and over the incline frame; providing a cart comprising wheels; sliding the incline frame up to the front end of the base; deploying the cable near a bottom of the deployed attic staircase; attaching a cart to the cable; activating the winch so that the cart is pulled up the deployable staircase and onto the incline frame; sliding the incline frame with the cart from the front end of the base to the rear end of the base; and removing items from the cart or placing items onto the cart.

It should be understood, of course, that the foregoing relates to exemplary embodiments of the invention and that modifications may be made without departing from the spirit and scope of the invention as set forth in the following claims.

What is claimed is:

1. A lift for an attic staircase comprising:
a base comprising a front end and a rear end, wherein the base is configured to be attached within an attic and wherein the front end is oriented near an entrance to the attic;
an incline frame attached to the base near the front end of the base, wherein the incline frame is oriented in an angle substantially similar to the angle of an attic staircase leading to the entrance;
a winch comprising a cable having a first end and a second end, wherein the first end is attached to the winch and the second end comprises an attachment component configured to attach to a cart, wherein the cable runs along at least a portion of the incline frame.

2. The lift of claim 1, further comprising a pulley mounted near a top end of the incline frame, wherein the cable runs from the winch through the pulley and along the incline frame.

3. The lift of claim 1, wherein the incline frame is slidably connected to the base, wherein the incline frame is configured to be repositioned along the length of the base from the front end to the rear end.

4. The lift of claim 3, wherein the incline frame and the base are slidably connectable by:
a first channel running along a first side of the base and a second channel running along a second side of the base;
a first ridge and a second ridge along the bottom of the incline frame, wherein the first ridge and the second ridge fit within the first channel and the second channel respectively; and
a plurality of rollers attached to the incline frame configured to allow the first ridge and second ridge to slide along the first channel and second channel.

5. The lift of claim 1, wherein the winch is at least one of an automated winch and a manual winch.

6. The lift of claim 1, further comprising the cart comprising:
a cart base comprising a cart frame and a cart bottom, wherein the cart base comprises a front end and a rear end;
a plurality of wheels mounted to the cart, wherein the wheels are spaced apart to roll along the incline frame.

7. The lift of claim 6, further comprising a cart back protruding from the rear end of the cart base in a substantially perpendicular position relative to the cart base.

8. The lift of claim 7, wherein the cart back is pivotally connected to the cart back by a hinge.

9. A method of transporting items to and from an attic comprising:
mounting a base to an attic floor, wherein the base comprises a front end and a rear end, wherein the front end is adjacent to an attic entrance;
slidably connecting an incline frame to the base, wherein the incline frame is oriented at a substantially similar angle as a deployable staircase of the attic;
providing a winch comprising a cable, wherein the cable runs from the winch and over the incline frame;
providing a cart;
sliding the incline frame up to the front end of the base;
deploying the cable near a bottom of the deployed attic staircase;
attaching the cart to the cable; and
activating the winch so that the cart is pulled up the deployable staircase and onto the incline frame.

10. The method of claim 9 further comprising the steps of:
sliding the incline frame with the cart from the front end of the base to the rear end of the base; and
removing items from the cart or placing items onto the cart.
